(19) United States
(12) Patent Application Publication
(10) Pub. No.: US 2018/0175437 A1
(43) Pub. Date: Jun. 21, 2018

(54) BATTERY

(71) Applicant: Murata Manufacturing Co., Ltd., Nagaokakyo-shi (JP)

(72) Inventors: Yoshihide Amagai, Nagaokakyo-shi (JP); Masayoshi Tanida, Nagaokakyo-shi (JP)

(21) Appl. No.: 15/899,921

(22) Filed: Feb. 20, 2018

Related U.S. Application Data
(63) Continuation of application No. PCT/JP2016/074326, filed on Aug. 22, 2016.

(30) Foreign Application Priority Data
Sep. 3, 2015 (JP) 2015-173889

(51) Int. Cl. H01M 10/04; H01M 2/10; H01M 10/0525

(52) U.S. Cl. CPC H01M 10/0481; H01M 2220/20; H01M 10/0525; H01M 2/1077

(57) ABSTRACT

A battery that include at least one battery cell; a pair of pressurizing members that sandwich and hold the at least one battery cell while applying a predetermined pressing force; and a lock mechanism constructed such that, when a force greater than the predetermined pressing force applied to the at least one battery cell by the pair of pressurizing members is exerted in a direction opposite to the predetermined pressing force, the operation of the pressurizing members is regulated so that the at least one battery cell is held between the pair of pressurizing members with the predetermined pressing force applied thereto.

### CROSS REFERENCE TO RELATED APPLICATIONS

The present application is a continuation of International application No. PCT/JP2016/074326, filed Aug. 22, 2016, which claims priority to Japanese Patent Application No. 2015-173889, filed Sep. 3, 2015, the entire contents of each of which are incorporated herein by reference.

### FIELD OF THE INVENTION

The present invention relates to a battery, and more particularly to a battery that has a structure in which a battery cell including a positive electrode member, a negative electrode member, and an electrolyte is held between a pair of pressurizing members.

### BACKGROUND OF THE INVENTION

In recent years, batteries have been widely used for power sources of automobiles. The battery (assembled battery) as disclosed in Patent Document 1 is listed as one of the batteries used for such applications.

More specifically, this battery (assembled battery) includes a battery stacked body composed of a plurality of flattened batteries, a pair of pressurizing plates that sandwich the battery stacked body, a pair of pressurizing force applying members that sandwich the pair of pressurizing plates, and a connecting member that can connect the pair of pressurizing force applying members and bias the respective pressurizing force applying members in the direction of bringing the members close to each other, and the battery is configured so that when the pressurizing force applying members are brought close to each other by the connecting member, the pair of pressurizing plates can move in a direction close to each other to apply a pressurizing force to the battery stacked body.

Further, in accordance with the battery configured as described above in Patent Document 1, the pair of pressurizing plates pressurize the battery stack body entirely rather than locally through the pair of pressurizing force applying members. It is thus said to be possible to provide a uniform pressurizing force to each flattened battery with a small number of components, and provide an assembled battery which is reduced in size and weight and favorable in terms of assembling efficiency and maintainability.

Indeed, from the standpoint of preventing performance deterioration caused by an increase in the internal pressure of the flattened battery (battery cell) due to the gas generated by the repetition of discharge and charge, it is meaningful to adopt such a configuration as that of the battery disclosed in Patent Document 1.

However, the excessively increased pressure applied to the flattened battery (battery cell) by the pressurizing force applying members and the pressurizing plate has the problem of causing breakage of the battery cell and performance deterioration, and there is a need to control the pressure applied to the battery cell within a predetermined range.

Furthermore, for example, a method of pressurizing the battery cell via a biasing member such as a spring can be considered as a method for applying a moderate pressure to the battery cell.

However, the method of pressurizing the battery cell via a biasing member such as a spring has the problem of, when the battery cell receives a shock, for example, at the time of falling down, spring contraction causes the battery cell to fall off from between the pressurizing plates, thereby causing a deformation, a breakage or the like.
Patent Document 1: Japanese Patent Application Laid-Open No. 2006-040696

### SUMMARY OF THE INVENTION

The present invention is intended to solve the above-mentioned problems, and it is an object of the invention to provide a highly reliable battery which can apply a predetermined pressing force to a battery cell between pressing members, and prevent the battery cell from falling off between the pressing members even in the case of receiving such a shock as received, for example, at the time of falling down.

In order to solve the above-mentioned problems, a battery according to an embodiment the present invention includes at least one battery cell including a positive electrode member, a negative electrode member, and an electrolyte; a pair of pressurizing members that sandwich and hold the at least one battery cell while applying a pressure to the battery cell from both sides of the battery cell with a predetermined pressing force; and a lock mechanism constructed such that, when a force greater than the predetermined pressing force applied to the at least one battery cell by the pair of pressurizing members is exerted in a direction opposite to the predetermined pressing force, an operation of the pair of pressurizing members is regulated so that the at least one battery cell is held between the pair of pressurizing members with the predetermined pressing force applied thereto.

In addition, in the battery according to an aspect of the present invention, the lock mechanism is preferably configured not to interfere with the operation of the pressurizing members in a direction of pressing the battery cell.

When such a load that prevents the operation of the pressurizing members in the direction of pressing the battery cell is applied by the lock mechanism, the pressing force applied to the battery cell by the pressurizing members will not all be entirely applied to the battery cell, thereby making it impossible to reliably apply a predetermined pressing force (desired pressing force) to the battery cell. In addition, the lock mechanism is configured not to interfere with the operation of the pressurizing members in the direction of pressing the battery cell, thereby making it possible to reliably add an appropriate pressing force to the battery cell.

Further, preferably, the at least one battery cell is a plurality of stacked battery cells sandwiched and held between the pair of pressurizing members, with the predetermined pressing force applied to each of the battery cells in a stacking direction.

The above-mentioned configuration makes it possible to create a large-capacity battery.

In addition, at least one of the pair of pressurizing members is preferably pressed toward the battery cell through a spring so that the battery cell is held between the pair of pressurizing members with the predetermined pressing force applied by the spring.

The battery is configured so that at least one of the pair of pressurizing members is pressed toward the battery cell through the spring, thereby making it possible to prevent the pressurizing members from excessively increasing the force of pressing the battery cell, and thus reliably press with a predetermined pressing force.

The battery according to the present invention provides a highly reliable battery which can apply a predetermined pressing force to a battery cell between pressurizing members, and prevent the battery cell from falling off between the pressurizing members even in the case of receiving shock, for example, at the rime of falling down or the like.

### BRIEF EXPLANATION OF THE DRAWINGS

FIG. 1 is a plan view of a battery according to an embodiment of the present invention.

FIG. 2(a) is a cross-sectional view taken along the line A-A of FIG. 1, which is a cross-sectional view illustrating a main part of the battery according to the embodiment of the present invention, and FIG. 2(b) is a cross-sectional view taken along line B-B of FIG. 1, which is an enlarged view schematically illustrating the configuration of a lock mechanism provided in the battery according to the embodiment of the present invention.

FIG. 3 is a schematic diagram for explaining the operation of the lock mechanism provided in the battery according to the present invention.

### DETAILED DESCRIPTION OF THE INVENTION

Features of the present invention will be described in more detail below with reference to an embodiment of the present invention.

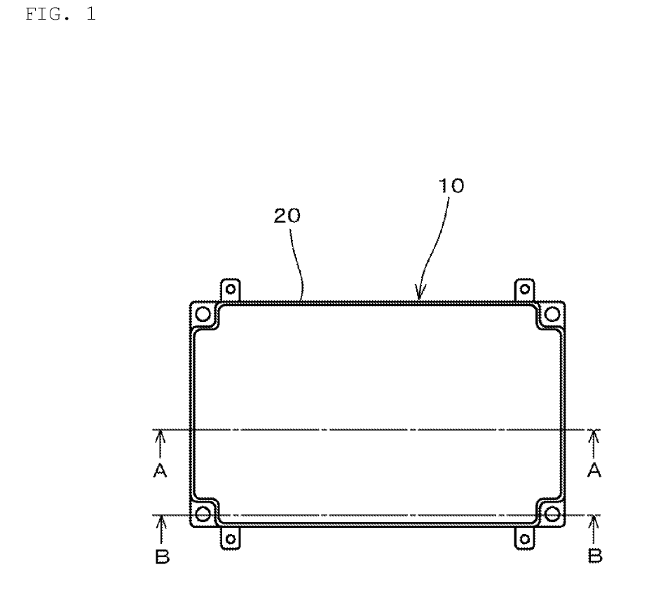

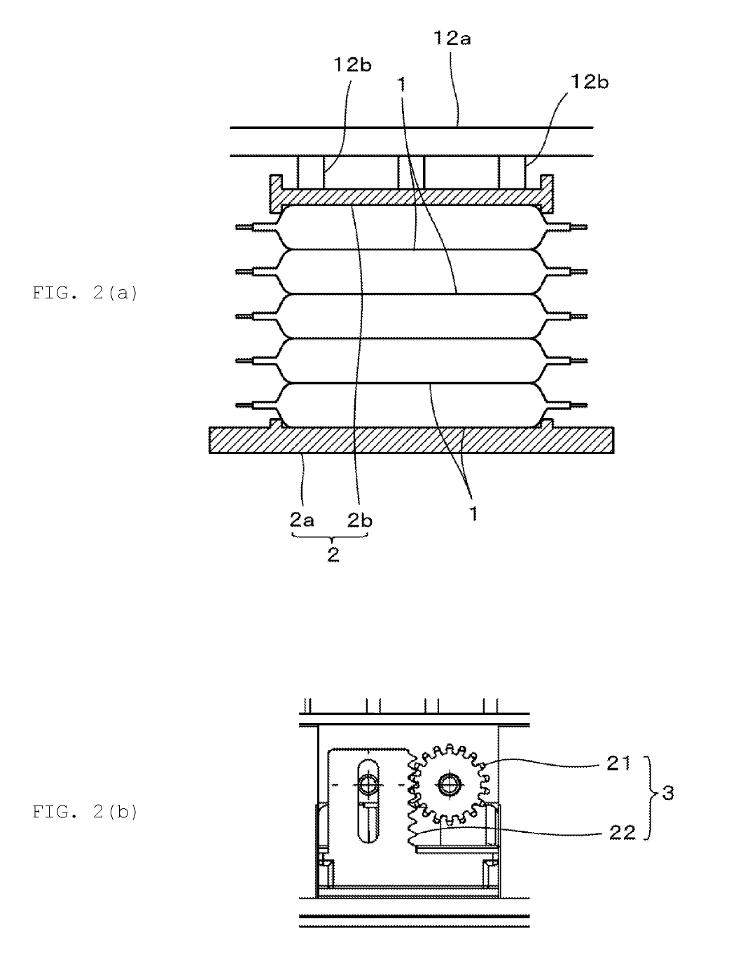

FIG. 1 is a plan view illustrating a battery (assembled battery) according to an embodiment of the present invention, FIG. 2(a) is a cross-sectional view taken along the line A-A of FIG. 1, and FIG. 2(b) is a cross-sectional view taken along the line B-B of FIG. 1, which is a diagram illustrating the configuration of a lock mechanism provided in the battery according to the embodiment of the present invention.

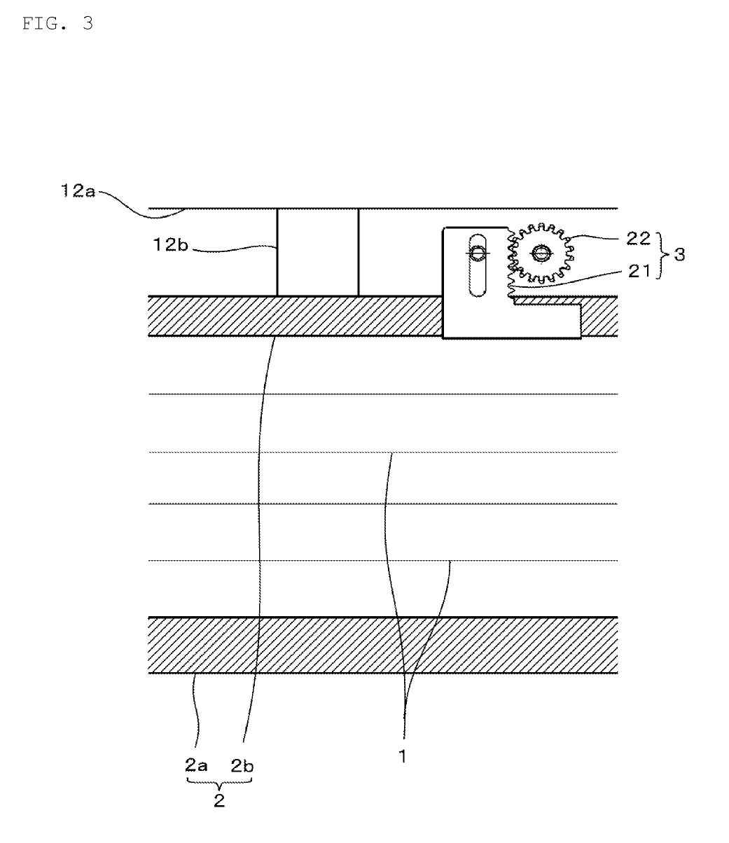

A battery 10 according to Embodiment 1 herein includes, as shown in FIGS. 1 and 2(a) and 2(b), a plurality of battery cells 1, a pair of pressurizing members 2 that sandwich the battery cells 1 from both sides in a stacking direction, and holds the battery cells 1 while pressurizing the cells from both sides with a predetermined pressing force, and a lock mechanism 3 (FIG. 2(b) and FIG. 3) that, when a force greater than the predetermined pressing force mentioned above is exerted in a direction opposite to the direction from the pressurizing members 2 toward the battery cells 1, regulates the operation of the pressurizing members 2 so that the battery cells 1 with a predetermined pressing force applied thereto are held between the pair of pressurizing members 2. These battery elements are housed in a case 20 (FIG. 1).

It is to be noted that the battery cell 1 constituting the battery 10 according to this embodiment is a lithium ion secondary battery, which is formed by housing an electrolyte inside an exterior material with a positive electrode member and a negative electrode member.

However, in the battery according to the present invention, there are no particular restrictions on the type and configuration of the battery cell, and various battery cells can be used.

In addition, there is also no particular limitation on the structure of the battery cell, and various structures can be used, such as, for example, a stacked structure in which a positive electrode and a negative electrode are stacked with a separator interposed therebetween, and housed together with an electrolyte inside an exterior material, and a structure for which a positive electrode and a negative electrode are provided on one and the other sides of a separator, wound, and then pressed into a flattened shape.

In addition, the battery 10 according to this present embodiment is adapted such that the stacked body with a plurality of battery cells 1 is held between the pressing members 2, but in some cases, it is also possible to configure the battery such that a single battery cell 1 is held between the pressing members 2.

In addition, one of the pair of pressurizing members 2 constituting the battery 10 according to this embodiment is a stationary plate-like member (fixed plate) 2a disposed in a fixed fashion, which is not particularly operated, and the other thereof is a movable plate-like member (movable plate) 2b configured to allow the operation in a first direction toward the battery cells 1 and a second direction opposite thereto.

In addition, the upper surface of the movable plate-like member 2b is provided with a plate 12a, and a spring 12b so as to be positioned between the plate 12a and the movable plate-like member 2b. It is to be noted that in the battery 10 according to this embodiment, the movable plate-like member 2b is configured so as to allow the operation in the first direction toward the battery cells 1 and the second direction opposite thereto through the expansion and contraction of the spring 12b.

In addition, in the battery 10 according to this embodiment, in consideration of the dimension of the stacked body of the plurality of battery cells 1 in the thickness direction and the magnitude of the biasing force of the spring 12b, the distance between the stationary plate-like member 2a and the plate 12a is determined so as to apply a predetermined pressing force to the battery cells 1.

More specifically, the stacked body of the battery cells 1, the movable plate-like member 2b, and the spring 12b are positioned between the stationary plate-like member 2a and the plate 12a with a predetermined interval therebetween, and the movable plate-like member 2b is pressed toward the battery cells 1 with the spring 12b interposed therebetween, thereby consistently applying a pressing force within a predetermined range to the battery cells 1 in a stable manner through the expansion and contraction of the spring 12b which is the biasing member.

It is to be noted that according to this embodiment, the battery is configured such that the pressing force applied to the battery cells 1 falls within the range of 100 N or more and 400 N or less.

In addition, the battery 10 according to this embodiment is provided with a lock mechanism that is a ratchet mechanism attached to one end (or both ends) of the movable plate-like member 2b and that is a ratchet mechanism composed of an interlocking gear 21 that interlocks with the movement of the movable plate-like member 2b and a regulating gear 22 that regulates the operation of the interlocking gear 21 as shown in FIG. 2(b) and FIG. 3.

It is to be noted that the regulating gear (one-way hinge in this embodiment) 22 is configured to rotate in the counterclockwise direction without resistance, but not to rotate in the clockwise direction. Further, the regulating gear 22 is attached to a site that does not interlock with the movement of the movable plate-like member 2b, for example, a predetermined location of the plate 12a.

Next, the function and operation of the lock mechanism 3 will be described with reference to FIG. 3.

For example, when the movable plate-like member 2b tries to move in a direction in which the pressing force to the battery cells 1 is removed (that is, the upward direction in FIG. 2 (a) and FIG. 3) due to the shock caused when the battery 10 falls down, the movement (upward movement) of the interlocking gear 21 that tries to move in the upward direction in conjunction with the movable plate-like member 2b is blocked by the regulating gear 22 that does not rotate in the clockwise direction. As a result, the upward movement of the movable plate-like member 2b that interlocks with the interlocking gear 21 will be blocked, thereby keeping the battery cells 1 with a predetermined pressing force applied between the stationary plate-like member 2a and the movable plate-like member 2b.

The battery (assembled battery) according to this embodiment is configured as described above, and provided with the lock mechanism 3 that regulates the movement of the movable side plate-like member 2b when a force greater than a predetermined pressing force applied to the battery cells 1 is applied in a direction opposite to the direction from the stationary plate-like member 2a or movable plate-like member 2b constituting the pressurizing member 2 toward the battery cells 1, and thus, for example, in such a case as a shock due to fall of the battery 10, it is possible to prevent the battery cells 1 from falling off between the stationary plate-like member 2a and the movable plate-like member 2b, thereby making it possible to provide the battery 10 with high reliability.

In addition, the spring 12b, which is a biasing member, is provided between the plate 12a and the movable plate-like member 2b so that the movable plate-like member 2b is pressed against the battery cells 1 with the spring 12b interposed between the plate 12a and the movable plate-like member 2b, the function of the spring 12b as a biasing member can consistently apply a pressing force within a predetermined range to the battery cells 1. As a result, it becomes possible to prevent performance degradation due to damage to the positive electrode or the negative electrode, because of the shifted positional relationship between the battery elements, with the increase in the internal pressure of the battery cell due to the gas generated by the repetition of discharge and charge, and the battery 10 with high reliability can be provided.

It is to be noted that in this embodiment, the case where the lock mechanism 3 includes the interlocking gear 21 and the regulating gear 22 that regulates the operation of the interlocking gear 21 has been described as an example, but in the battery according to the present invention, it is also possible to adopt other lock mechanisms, such as a ratchet mechanism composed of an interlocking gear and a pawl (ratchet).

In addition, the present embodiment described above is adapted such that the stacked body with a plurality of battery cells 1 is held between the pressurizing members 2, but it is also possible to configure the battery such that a single battery cell 1 is held between the pressurizing members 2.

The present invention is not to be considered limited to the embodiment described above in still other respects, but various applications and modifications can be made within the scope of the invention, in regard to the specific configurations of the battery cells and the pair of pressurizing members.

### DESCRIPTION OF REFERENCE SYMBOLS

1: battery cell
2: a pair of pressurizing members
2a: stationary plate-like member as one of the pair of pressurizing members
2b: movable plate-like member as the other of the pair of pressurizing members
3: lock mechanism
12a: plate
12b: spring (biasing member)
21: interlocking gear
22: regulating gear

1. A battery comprising:
at least one battery cell;
a pair of pressurizing members that sandwich and hold the at least one battery cell while applying a predetermined pressing force to the at least one battery cell; and
a lock mechanism constructed such that, when a force greater than the predetermined pressing force applied to the at least one battery cell by the pair of pressurizing members is exerted in a direction opposite to the predetermined pressing force, an operation of the pair of pressurizing members is regulated so that the at least one battery cell is held between the pair of pressurizing members with the predetermined pressing force applied thereto.

2. The battery according to claim 1, wherein the lock mechanism is constructed to not interfere with operation of the pressurizing members in a direction of the predetermined pressing force applied to the at least one battery cell.

3. The battery according to claim 2, wherein the at least one battery cell is a plurality of stacked battery cells sandwiched and held between the pair of pressurizing members, and the predetermined pressing force is applied to each of the plurality of stacked battery cells in a stacking direction thereof.

4. The battery according to claim 3, wherein at least one of the pair of pressurizing members is pressed toward the plurality of stacked battery cells through a spring so that the plurality of stacked battery cells is held between the pair of pressurizing members, and the spring is constructed to provide the predetermined pressing force.

5. The battery according to claim 1, wherein the at least one battery cell is a plurality of stacked battery cells sandwiched and held between the pair of pressurizing members, and the predetermined pressing force is applied to each of the plurality of stacked battery cells in a stacking direction thereof.

6. The battery according to claim 5, wherein at least one of the pair of pressurizing members is pressed toward the plurality of stacked battery cells through a spring so that the plurality of stacked battery cells is held between the pair of pressurizing members, and the spring is constructed to provide the predetermined pressing force.

7. The battery according to claim 1, wherein at least one of the pair of pressurizing members is pressed toward the at least one battery cell through a spring so that the at least one battery cell is held between the pair of pressurizing members, and the spring is constructed to provide the predetermined pressing force.

8. The battery according to claim 1, wherein the locking mechanism comprises a ratchet mechanism that includes an interlocking gear that interlocks with at least one of the pair of pressurizing members, and a regulating gear that regulates operation of the interlocking gear.

9. The battery according to claim 8, wherein the regulating gear is constructed to rotate in a first direction without resistance, but not rotate in a second direction opposite to the first direction.

10. The battery according to claim 9, wherein the regulating gear is constructed to not interfere with operation of the at least one of the pressurizing members that is interlocked with the interlocking gear.
